(19) United States
(12) Patent Application Publication
(10) Pub. No.: US 2012/0331465 A1
(43) Pub. Date: Dec. 27, 2012

(54) VIRTUAL MACHINE SYSTEM, VIRTUAL MACHINE CONTROL METHOD, VIRTUAL MACHINE CONTROL APPLICATION, AND SEMICONDUCTOR INTEGRATED CIRCUIT

(76) Inventor: Tadao Tanikawa, Osaka (JP)

(21) Appl. No.: 13/583,151

(22) PCT Filed: Sep. 12, 2011
(86) PCT No.: PCT/JP2011/005108

§ 371 Date: Sep. 6, 2012

(30) Foreign Application Priority Data
Mar. 2, 2011 (JP) 2011-045323

(51) Int. Cl. G06F 9/455

(52) U.S. Cl. 718/1

(57) ABSTRACT

A memory protection unit controls access by virtual machines to memory areas. By having a hypervisor executed by a processor and the memory protection unit cooperate, access to memory areas by each virtual machine is controlled such that access to designated areas is forbidden. Accordingly, each virtual machine is unable to access programs, data, and so on stored in areas forbidden thereto.

### TECHNICAL FIELD

The present invention relates to a virtual machine system, and particularly pertains to technology for controlling access to memory areas by virtual machines.

### BACKGROUND ART

Conventionally, a system that controls the execution of a plurality of virtual machines (hereinafter, VMs) is known as a virtual machine system.

Technology for dynamically controlling the generation and termination of VMs in response to the processing load on the virtual machine system has been proposed as a means of increasing the usage efficiency of hardware resources in the virtual machine system.

For example, Patent Literature 1 discloses technology for generating a child VM by forking from a parent VM, and Patent Literature 2 discloses technology for generating a child VM by cloning a VM in response to a request from an application being executed thereby.

### CITATION LIST

### Patent Literature

[Patent Literature 1]

Japanese Patent Application Publication No. 2004-133894

[Patent Literature 2]

Japanese Patent Application Publication No. 2008-165795

### SUMMARY OF INVENTION

### Technical Problem

As it happens, applications subject to execution in the virtual machine system are divisible into two categories: applications authenticated as not containing any malware (hereinafter, authenticated applications) and applications not authenticated with regard to malware presence (hereinafter, unauthenticated applications).

Given such circumstances, there is a possibility that any malware included in an unauthenticated application may, when executed, attack an authenticated application.

Should an authenticated application be attacked in this way, then, for example, the authenticated application or data may be tampered with, or the authenticated application under attack may be executed illicitly, resulting in system administrative privileges being stolen and the computer system being taken over, such that, data meant to be confidential, e.g., paid content, personal information, and encryption keys, stored on the system may be read out.

Conventionally, when a virtual machine system dynamically generating VMs executes a new application and no VM is available for executing that application, a child VM is generated from a parent VM and the child VM executes the application.

In such circumstances, the child VM generated from the parent VM has the same functions as the parent VM. Accordingly, provided that authenticated applications are included in the set of applications executable by the parent VM, the child VM generated to execute the unauthenticated application is also able to execute the same authenticated applications.

Accordingly, in the conventional virtual machine system, should malware be included in the unauthenticated application executed by the child VM, then the malware is able to attack the authenticated applications.

In consideration of the above-described problem, the present invention seeks to provide a virtual machine system that, despite the presence of authenticated and unauthenticated applications as executable by the VMs, is able to prevent illicit software execution, such as system takeovers, data theft, and attacks on authenticated applications, despite execution of malware included in an unauthenticated application.

### Solution to Problem

In order to solve the above-described problem, a virtual machine system pertaining to the present invention includes a memory unit, a processor connected to the memory unit, and a hypervisor running on the processor and causing the processor to perform execution control on a plurality of virtual machines, the virtual machine system comprising an access controller controlling access by the virtual machines to memory areas of the memory unit, wherein the memory unit includes a first memory area storing a type-1 program and a second memory area storing a type-2 program, the hypervisor includes: a startup request reception module for receiving a type-1 or type-2 program startup request from the virtual machines; and a virtual machine generation module for, upon receipt of the type-1 program startup request by the startup request reception module, generating a new virtual machine for executing the type-1 program and managing the new virtual machine as a type-1 virtual machine, and for, upon receipt of the type-2 program startup request by the startup request reception module, generating a new virtual machine for executing the type-2 program and managing the new virtual machine as a type-2 virtual machine, and the access controller performs access control so as to forbid access to the second memory area by the new virtual machine managed by the virtual machine generation module as the type-1 virtual machine.

### Advantageous Effects of Invention

According to the virtual machine system having the above-described configuration, an unauthenticated application is stored as a type-1 program in a first memory area, while an authenticated application is stored as a type-2 program in a second memory area. Thus, a virtual machine running the unauthenticated application is unable to access the authenticated application.

Accordingly, although authenticated and unauthenticated applications are both present as executable by the VMs, the virtual machine system is able to prevent illicit software execution, such as system takeovers, data theft, and attacks on authenticated applications, despite execution of malware included in an unauthenticated application.

### BRIEF DESCRIPTION OF DRAWINGS

FIG. 1 is a block diagram illustrating the main hardware configuration of a virtual machine system 100.

FIG. 2 is a diagram illustrating the operating mode of a processor 101.

FIG. 3 is a diagram illustrating the data configuration of a memory protection table.

FIG. 4 is a diagram illustrating the data configuration of memory protection information.

FIG. 5 is a diagram illustrating memory area divisions in a memory 102.

FIG. 6 is a block diagram illustrating a program module subject to execution by the processor 101.

FIG. 7 is a data configuration diagram of an application group management table 700.

FIG. 8 is a data configuration diagram of a VM management table 800.

FIG. 9 is a data configuration diagram of a VM status table 900.

FIG. 10 is a data configuration diagram of access permissions information 1000.

FIG. 11 is a diagram illustrating further memory area divisions in the memory 102.

FIG. 12 is a flowchart of a VM switching process.

FIG. 13 is a flowchart of a memory access process.

FIG. 14 is a flowchart of an application execution process.

FIG. 15 is a block diagram illustrating the main hardware configuration of a virtual machine system 1500.

FIG. 16 is a block diagram illustrating program modules executed by the processor 101.

FIG. 17 is a block diagram illustrating program modules executed by the processor 101.

FIG. 18 is an overall outline diagram of a variant virtual machine system 1800.

### DESCRIPTION OF EMBODIMENTS

### Embodiment 1

(Outline)

An Embodiment of the virtual machine system pertaining to the present invention is described below as including a processor having two modes for program execution, namely a user mode for executing applications and a supervisor mode above the user mode, wherein a hypervisor executed in the supervisor mode performs time-sharing execution control of a plurality of operating systems also executed in the supervisor mode.

In addition to the processor, the virtual machine system comprises a memory protection unit performing access control for memory areas from the VMs. Thus, by having the hypervisor executed by the processor and the memory protection unit operate in cooperation, access to memory areas by each VM is controlled such that access to designated areas is forbidden.

Accordingly, each VM being run by the virtual machine system is unable to access programs, data, and so on stored in memory areas to which access is forbidden thereto.

The following describes a virtual machine system pertaining to Embodiment 1, with reference to the accompanying drawings.

(Hardware Configuration)

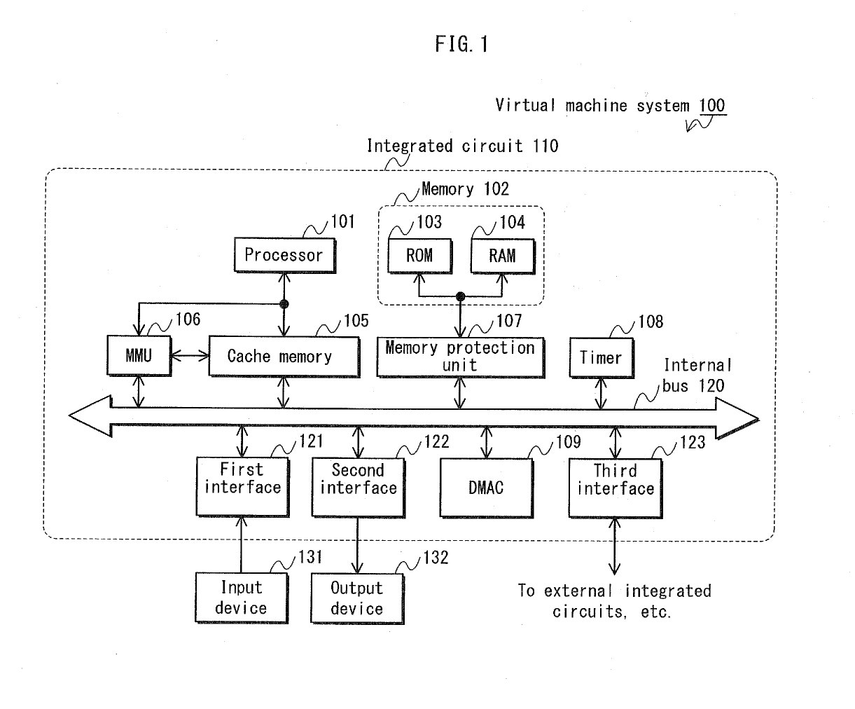

FIG. 1 is a block diagram illustrating the main hardware configuration of a virtual machine system 100.

As shown, the hardware of the virtual machine system 100 is a computer that includes an integrated circuit 110, an input device 131, and an output device 132.

The integrated circuit 110 is a semiconductor integrated circuit having a processor 101, memory 102, cache memory 105, a memory management unit (hereinafter, MMU) 106, a memory protection unit 107, a timer 108, a direct memory access controller (hereinafter, DMAC) 109, an internal bus 120, a first interface 121, a second interface 122, and a third interface 123 integrated therein. The integrated circuit 110 is connected to the input device 131, the output device 132, and external integrated circuits. The memory 102 is in turn made up of read-only memory (hereinafter, ROM) 103 and random access memory (hereinafter, RAM) 104.

The processor 101, being connected to the cache memory 105 and to the MMU 106, executes applications stored in the ROM 103 or in the RAM 104, thus controlling the ROM 103, the RAM 104, the cache memory 105, the MMU 106, the memory protection unit 107, the timer 108, the input device 131, and the output device 132 to realize various functions.

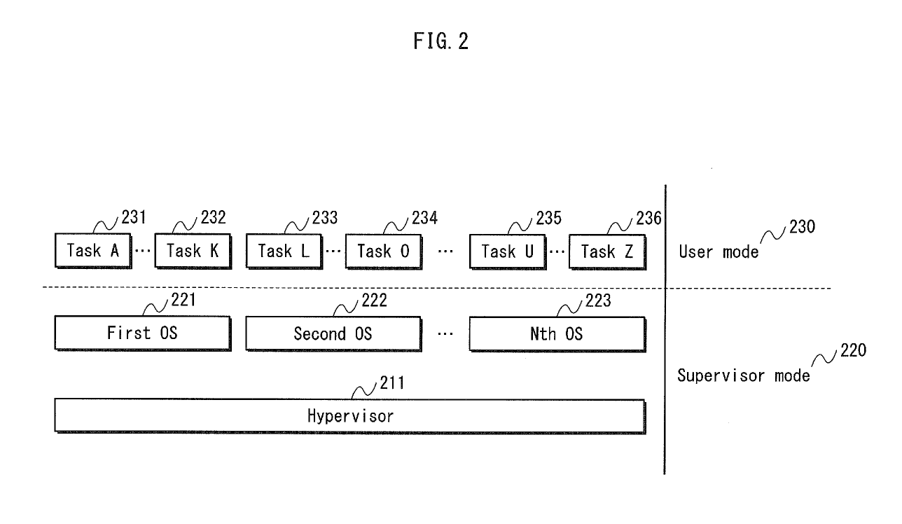

FIG. 2 is a diagram illustrating an operating mode of the processor 101.

As shown, the processor 101 has a user mode 230 for executing applications (shown as task A 231, task K 232, task L 233, and so on) and a privileged mode (hereinafter, supervisor mode) 220 for executing a hypervisor and operating systems (hereinafter, OS) (shown as a first OS 221, a second OS 222, a third OS 223, and so on).

The applications executed in the user mode 230 are controlled through time-sharing execution by the operating systems running in the supervisor mode 220. Similarly, the operating systems executed in the supervisor mode 220 are controlled through time-sharing by the hypervisor executed in the supervisor mode 220.

The following continues the description of the configuration of the virtual machine system 100 with reference to FIG. 1.

The ROM 103 is connected to the memory protection unit 107 and stores applications defining the operations of the processor 101, along with data used by the processor 101.

The RAM 104 is connected to the memory protection unit 107 and stores applications defining the operations of the processor 101, along with data used by the processor 101.

The cache memory 105 is connected to the processor 101, the MMU 106, and the internal bus 120, and is used by the processor 101.

The MMU 106 is connected to the processor 101, the cache memory 105, and the internal bus 120. The MMU 106 converts between physical addresses, each designating a physical memory area within the memory 102, and logical addresses, each designating a logical memory area used by the processor 101.

The memory protection unit 107 is connected to the memory 102 and to the internal bus 120, stores a memory protection table and memory protection information, and controls the access to the memory 102 by the bus master (here, the processor 101 or the DMAC 109) of the internal bus 120 by referencing the memory protection table and the memory protection information.

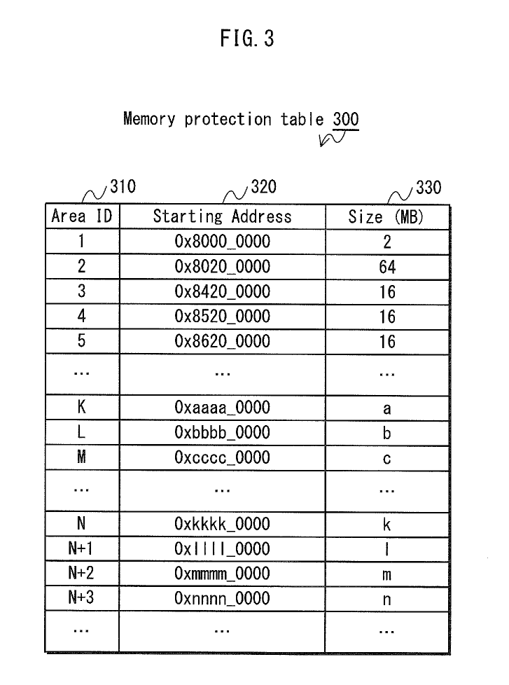

FIG. 3 is a diagram illustrating the data structure of the memory protection table 300 stored in the memory protection unit 107.

As shown, the memory protection table 300 is a list of area IDs 310, each associated with a starting address 320 and size 330.

Each area ID 310 is an identifier for identifying a designated memory area within the memory 102.

Each starting address 320 is the starting address of the designated memory area identified by the corresponding area ID 310.

The size 330 is given in megabytes and indicates the size of the designated memory area identified by the corresponding area ID 310.

In this example, the memory protection table 300 indicates that the designated memory area having area ID 310 1 has the starting address 0x8000_{—}0000 and is 2 megabytes (hereinafter, MB) in size.

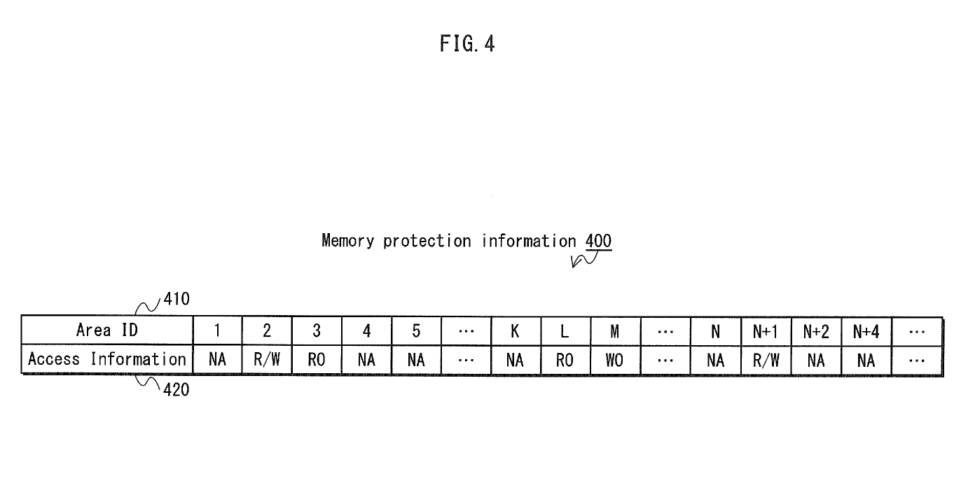

FIG. 4 is a diagram illustrating the data structure of the memory protection information 400 stored in the memory protection unit 107.

As shown, the memory protection information 400 is a list of area IDs 410, each associated with access information 420.

Like the area IDs 310, each area ID 410 is an identifier for identifying a designated memory area within the memory 102.

The access information 420 indicates the access control applied to the designated memory area identified by the corresponding area ID 410, and indicates one of (i) reading and writing are both allowed (hereinafter, R/W), (ii) reading is allowed while writing is not (hereinafter, RO), (iii) reading is not allowed while writing is (hereinafter, WO), and (iv) neither reading nor writing are allowed (hereinafter, NA).

In this example, the memory protection information 400 shows that neither reading nor writing are allowed in the designated memory area having area ID 310 1, that both reading and writing are allowed in the designated memory area having area ID 310 2, that reading is allowed while writing is not allowed in the designated memory area having area ID 310 3, that neither reading nor writing are allowed in the designated memory area having area ID 310 4, and so on.

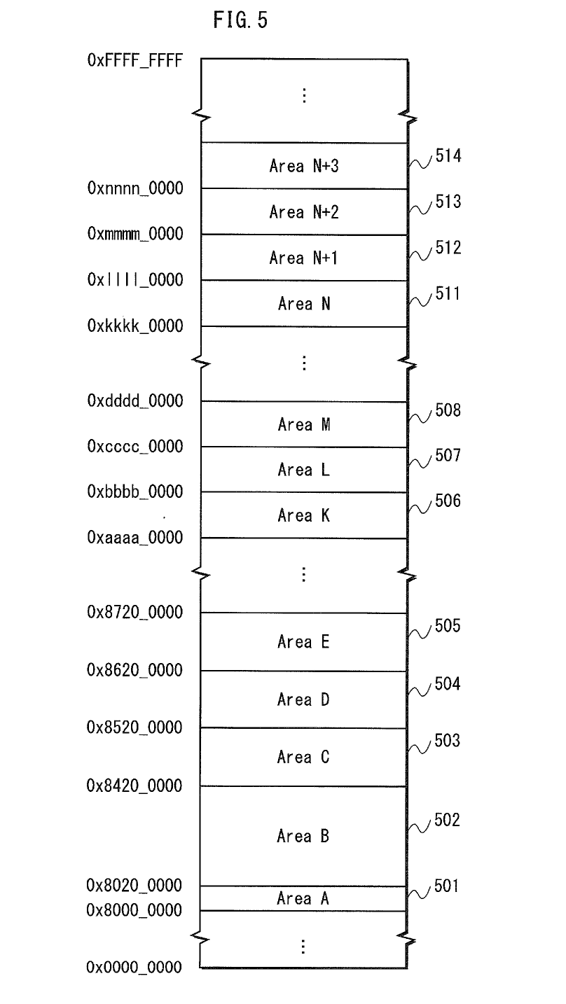

FIG. 5 is a memory area diagram illustrating the memory 102 as divided into a plurality of designated areas to which access is individually controlled by the memory protection unit 107.

As shown, the memory protection unit 107 references the memory protection table and thereby divides the memory 102 into area A 501 having area ID 310 1, area B 502 having area ID 310 2, area C 503 having area ID 310 3, area D 504 having area ID 310 4, and so on.

Further details of the access control operations performed by the memory protection unit 107 on the memory 102 are provided under the heading Memory Access Process, with reference to a flowchart.

The following continues the description of the configuration of the virtual machine system 100 with reference to FIG. 1.

The timer 108 is connected to the internal bus 120 and controlled by the processor 101.

The DMAC 109 is connected to the internal bus 120 and performs data transfer between the memory 102 and each of the input device 131 connected to the first interface 121, the output device 132 connected to the second interface 122, and the external integrated circuit connected to the third interface 123, without involving the processor 101.

The internal bus 120 is connected to the MMU 106, the cache memory 105, the memory protection unit 107, the timer 108, the first interface 121, the second interface 122, the third interface 123, and the DMAC 109, transporting signals between the circuits connected thereto.

The first interface 121, the second interface 122, and the third interface 123 are all connected to the internal bus 120, and serve as the respective signal exchange interfaces between the internal bus 120 and the input device 131, the output device 132, and the external integrated circuit.

The input device 131 is connected to the first interface 121 and includes a keyboard, a mouse, a camera, a sensor, and so on. The input device 131 is controlled by the processor 101 to generate data in response to user operations of the keyboard, the mouse, the camera, the sensor, and so on, and transmits a user operation notification along with the generated data to the processor 101.

The output device 132 is connected to the second interface 122 and includes a display, speakers, and so on. The output device 132 is controlled by the processor 101 to output text, images, audio, and the like using the display, the speakers, and so on.

The above-described virtual machine system 100 realizes various functions by having the processor 101 execute applications stored in the ROM 103 and the RAM 104.

(Application Module Configuration)

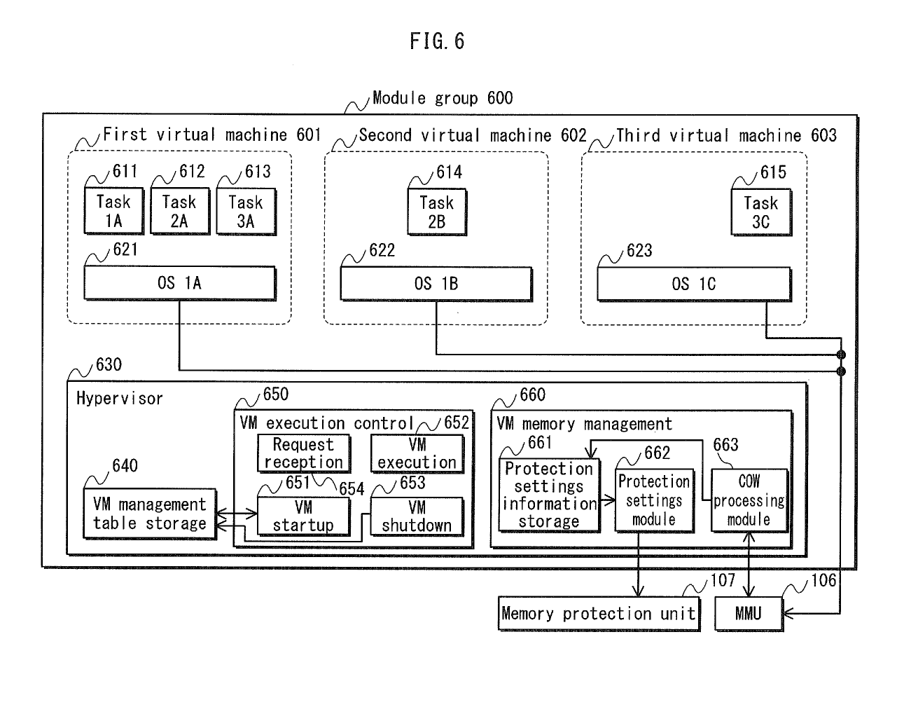

FIG. 6 is a block diagram of an application module (hereinafter, module) executable by the processor 101 at time t0.

As shown, a module group 600 is made up of a collection of modules executed by the processor 101. Each member module of the module group 600 is stored in an area of the memory 102.

Task 1A 611, task 2A 612, task 3A 613, task 2B 614, and task 3C 615 are each executed by the processor 101 in the user mode.

OS 1A 621, OS 1B 622, and OS 1C 623 are operating systems capable of multitasking, each executed by the processor 101 in the supervisor mode.

The hypervisor 630 is executed by the processor 101 in the supervisor mode.

In the virtual machine system 100, the execution of applications is controlled by the multitasking-compatible operating system executed in the supervisor mode, while the execution itself occurs in the user mode. Also, the execution of each operating system is controlled by the hypervisor, while the execution itself occurs in the supervisor mode.

An application is able to request specific processing by the operating system through an operating system call routine, prepared in advance. Also, the operating system is able to request specific processing by the hypervisor through a hypervisor call routine, prepared in advance.

Further, the hypervisor processes exceptions occurring in the execution of the virtual machine system, interruptions by external devices, and so on, and may redistribute such processing to the operating systems in the virtual machine, as required.

OS 1A 621 controls the execution of task 1A 611, task 2A 612, and task 3A 613, such that the system made up of OS 1A 621 and the tasks controlled thereby functions as a first virtual machine 601.

Similarly, OS 1B 622 controls the execution of task 2B 614 such that the system made up of OS 1B 622 and task 2B 614 functions as a second virtual machine 602.

OS 1C 623 controls the execution of task 3C 615 such that the system made up of OS 1C 623 and task 3C 615 functions as a third virtual machine 603.

Here, the second virtual machine 602 is a child VM generated by fork implementation, with the first virtual machine 601 as parent VM. Likewise, the third virtual machine 603 is a child VM generated by fork implementation, with the first virtual machine 601 as parent VM. Virtual machine generation by fork implementation is described later.

The hypervisor 630 includes three modules, namely a VM management table storage module 640, a VM execution control module 650, and a VM memory management module 660. The VM execution control module 650 further includes four modules, namely a VM startup module 651, a VM execution module 652, a VM shutdown module 653, and a request reception module 654. The VM memory management module 660 further includes three modules, namely a protection settings information storage module 661, a protection settings module 662, and a Copy-on-Write (hereinafter, COW) process module 663.

The VM management table storage module 640 stores a predetermined application group management table, a predetermined VM management table, and a VM status table generated by the VM execution module 652.

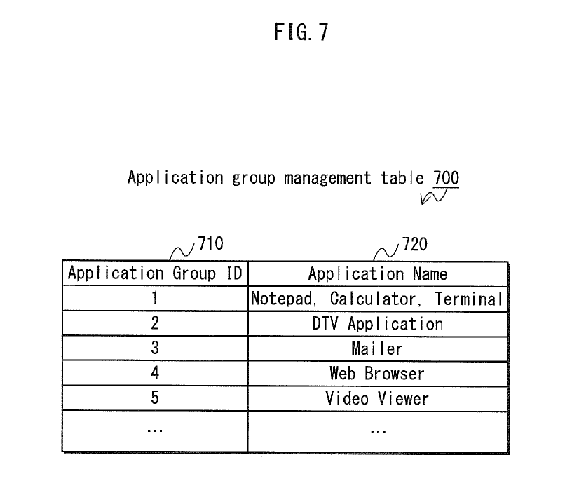

FIG. 7 illustrates the data structure of the application group management table 700 stored by the VM management table storage module 640.

As shown, the application group management table 700 lists application group IDs 710 in correspondence with application names 720.

An application name 720 is a name identifying a particular application.

An application group ID 710 is an identifier identifying an application group to which specific applications belong, each corresponding to an application name 720.

As indicated by the application group management table 700, a group of applications with names such as Notepad, Calculator, and Terminal all belong to an application group having application group ID 1, while a digital television (hereinafter, DTV) application belongs to an application group having application group ID 2.

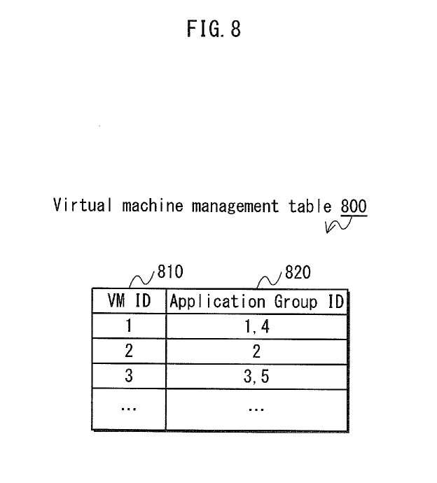

FIG. 8 illustrates the data structure of the VM management table 800 stored by the VM management table storage module 640.

As shown, the VM management table 800 lists VM IDs 810 in correspondence with application group IDs 820.

Application group IDs 820 and application group IDs 710 are identical.

A VM ID 810 is an identifier identifying a VM for executing applications belonging to a specific application group identified by a corresponding application group ID 820.

Acccording to the VM management table 800, for example, the VM identified by VM ID 810 1 is used to execute applications belonging to the application groups designated by application group IDs 820 1 and 4.

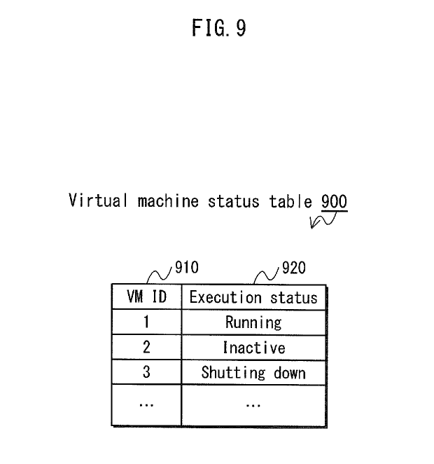

FIG. 9 illustrates the data structure of the VM status table 900 stored by the VM management table storage module 640.

As shown, the VM status table 900 lists VM IDs 910 in correspondence with execution statuses 920.

A VM ID 910 is an identifier identifying one of the VMs.

An execution status 920 is information indicating the status of the VM identified by the corresponding VM ID 910, and indicates one of the following: (1) the VM has been activated, is running under time-sharing, and is available for processing a new task (hereinafter, running); (2) the VM has not been started up (hereinafter, inactive); and (3) the VM has been started up and is running under time-sharing, but is currently executing a shutdown process and is not available for processing a new task (hereinafter, shutting down). The shutdown process for shutting down a VM is executed in order to free up the resources secured by the hypervisor and by the VM in question during execution.

The modules subject to execution by the processor 101 are described below with continuing reference to FIG. 6.

The request reception module 654 receives a new application startup request from the operating system in the VM currently running, then transmits a signal notifying the VM startup module 651 to such effect.

The VM startup module 651 has the following three functions.

Function 1: Generating a new child VM by fork implementation from the parent VM for executing a new application.

Generating a VM by fork implementation involves generating the new VM by mapping all memory areas allocated to the parent VM to the new VM so as to establish one-to-one correspondence between the memory areas allocated to the parent VM and the memory areas allocated to the new VM. Once the new VM has been generated, the memory areas of the parent VM and of the newly-generated VM are managed by the COW processor 663 through copy-on-write implementation. The details of memory area management by the COW processor 663 through copy-on-write implementation are described later.

Function 2: Once a child VM has been generated for executing a new application, referencing the application group management table 700 and the VM management table 800 stored in the VM management table storage module 640 to assign a VM ID to the new child VM for identification and then updating the execution status 920 in the VM status table 900 stored in the VM management table storage module 640 and corresponding to the VM ID so assigned to read “running”.

Function 3: Once the VM startup module 651 has been started up during processor 101 initialization, generating a VM to serve as parent VM to all other VMs and assigning VM ID 0 to the VM so generated.

The VM execution module 652 uses the timer 108 to control the implementation of time-sharing execution across multiple VMs.

The VM shutdown module 653 receives a shutdown request from the VM requesting shutdown. Upon receiving such a request, the VM shutdown module 653 executes the above-described shutdown process on the relevant VM, thereby shutting down the VM.

The protection settings information storage module 661 stores access permissions information.

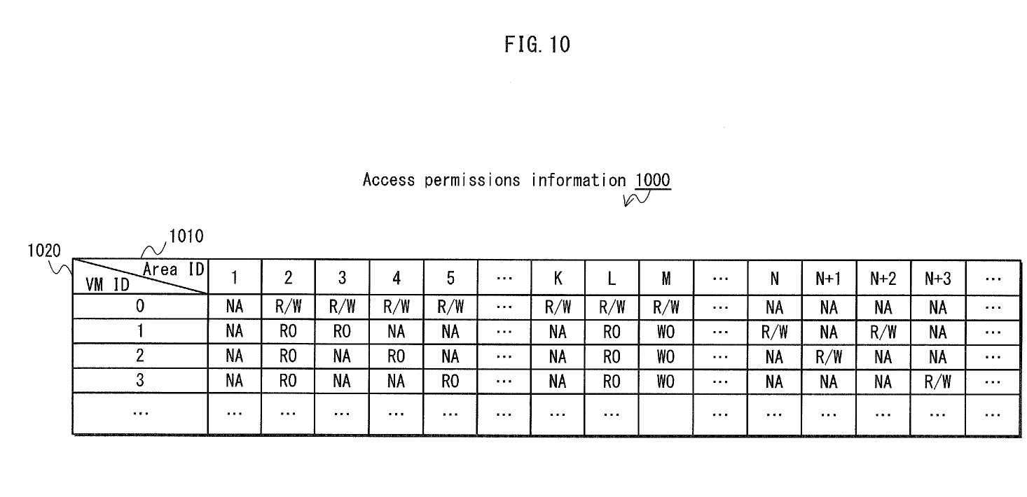

FIG. 10 illustrates the data structure of access permissions information 1000 stored by the protection settings information storage module 661.

As shown, the access permissions information 1000 lists area IDs 1010 in correspondence with VM IDs 1020 and access information (given as NA, R/W, RO, and so on).

The access permissions information 1000 is made up of original access information determined in advance (corresponding to area IDs 1010 1 through 6) and additions made by the COW processor 663 (corresponding to all area IDs 1010 other than 1 through 6).

Like the area IDs 310, each area ID 1010 is an identifier for identifying a designated memory area within the memory 102.

Like the VM IDs 910, a VM ID 1020 is an identifier identifying one of the VMs.

The access information indicates an access restriction imposed on a designated memory area identified by a corresponding area ID 1010, pertaining to the VM identified by the corresponding VM ID 1020. Similar to the previously-described access information 420, the access information indicates one of R/W, RO, WO, and NA.

In this example, the access permissions information 1000 shows that, for the

VM having VM ID 1020 1, neither reading nor writing are allowed in the designated memory area having area ID 1010 1, that reading is allowed while writing is not allowed in the designated memory area having area ID 1010 2, that reading is allowed while writing is not allowed in the designated memory area having area ID 1010 3, that neither reading nor writing are allowed in the designated memory area having area ID 1010, and so on.

The protection settings module 662 has the following two functions.

Function 1: When the VM execution module 652 switches between VMs, reading the access information corresponding to each area ID 1010 of the VM having a switch-target VM ID 1020 from the access permissions information 1000 stored in the protection settings information storage module 661, generating memory protection information 400 (see FIG. ), and updating the memory protection information 400 stored in the memory protection unit 107 with the memory protection information 400 so generated.

Function 2: When the COW processor 663 updates the access permissions information 1000 stored in the protection settings information storage module 661, reading the access information corresponding to each area ID 1010 of the currently-running VM from the access permissions information 1000 stored in the protection settings information storage module 661, generating memory protection information 400, and updating the memory protection information 400 stored in the memory protection unit 107 with the memory protection information 400 so generated.

The COW processor 663 has the following two functions.

Function 1: Performing access management through copy-on-write implementation concerning access to memory areas by VMs.

Copy-on-write implementation is an access management method used for managing pages of the parent VM memory areas and of the child VM memory areas such that pages not overwritten by either VM are shared between both VMs, while pages used by either one of the VMs are respectively allocated to different memory areas.

Function 2: Updating the access permissions information 1000 stored by the protection settings information storage module 661 when a memory area is newly allocated to a VM in the course of access management.

The updates to the access permissions information 1000 involve changing the access information for the newly allocated memory area corresponding to the area ID 1010 and to the VM ID 1020 identifying the VM to R/W, and changing the access information therefor corresponding to VM IDs 1020 identifying any other VM to NA.

When a VM is executing an unauthenticated application, the access information for newly-allocated memory areas may be set to RO or R/W in order to have the parent VM, or a VM executing an authenticated application, perform supervision or the like on itself or on the VM executing the unauthenticated application.

The second virtual machine 602 and the third virtual machine 603 are further described with reference to FIG. 6.

In order to execute task 2B 614, the second virtual machine 602 is generated by the VM startup module 651 by fork implementation, taking the first virtual machine 601 as parent VM.

Similarly, in order to execute task 3C 615, the third virtual machine 603 is generated by the VM startup module 651 by fork implementation, taking the first virtual machine 601 as parent VM.

Task 2B 614 is generated from task 2A 612 when the second virtual machine 602 is generated. The memory areas used by task 2A 612 and by task 2B 614 are managed by the COW processor 663 through copy-on-write implementation.

Task 3C 615 is generated from task 3A 613 when the third virtual machine 603 is generated. The memory areas used by task 3A 613 and by task 3C 615 are managed by the COW processor 663 through copy-on-write implementation.

OS 1B 622 and OS 1C 623 are operating systems corresponding to OS 1A 621 in the first virtual machine 601. OS 1B 622 is generated when the second virtual machine 602 is generated, while OS 1C 623 is generated when the third virtual machine 603 is generated. The memory areas respectively used by OS 1A 621, OS 1B622, and OS 1C 623 are managed by the COW processor 663 through copy-on-write implementation.

The virtual machine system 100, configured as described above, uses memory areas in the memory 102 in accordance to the following memory area usage method.

(Memory Area Usage Method for Memory 102)

The following describes the memory area usage method for the virtual machine system 100 using the memory 102, with reference to the drawings.

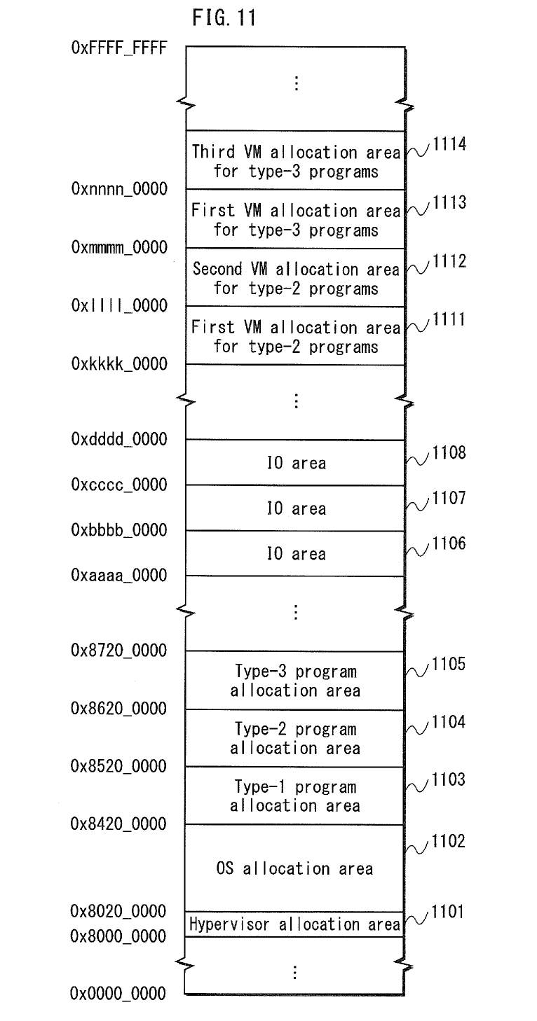

FIG. 11 illustrates the memory 102 as divided into designated memory areas, along with the usage method for each memory area, at time t0.

As shown, a hypervisor allocation area 1101 is designated at the memory area having area ID 1 (see FIG. 3), and corresponds to area A 501 from FIG. 5. This area is prepared in advance for storing the code of the hypervisor 630, or for use by the hypervisor 630. Furthermore, according to the original access information in the access permissions information 1000 stored by the protection settings information storage module 661, this area is prepared in advance such that neither reading nor writing are allowed for any of the VMs.

An operating system allocation area 1102 is designated at the memory area having area ID 310 2, and corresponds to area B 502 in FIG. 5. This area is prepared in advance to store the operating system code to be executed by the processor 101, or to be used by the operating system to be executed by the processor 101. This area is also prepared in advance such that access is only permitted for the processor 101 in the supervisor mode 220. Furthermore, according to the original access information in the access permissions information 1000 stored by the protection settings information storage module 661, this area is prepared in advance such that reading and writing are both allowed for the VM having VM ID 1020 0 (i.e., the first virtual machine 601, serving as the parent VM to all other VMs) while reading is allowed but writing is not allowed for any other VMs.

A type-1 application allocation area 1103 is designated at the memory area having area ID 310 3, and corresponds to area C 503 in FIG. 5. This area is prepared in advance to store an application belonging to the application group having application group ID 1 (hereinafter, type-1 application), or to be used by the type-1 application. Furthermore, according to the original access information in the access permissions information 1000 stored by the protection settings information storage module 661, this area is prepared in advance such that reading and writing are both allowed for the VM having VM ID 1020 0, that reading is allowed while writing is not allowed for the VM having VM ID 1020 1, and that neither reading nor writing are allowed for any other VMs.

A type-2 application allocation area 1104 is designated at the memory area having area ID 310 4, and corresponds to area D 504 in FIG. 5. This area is prepared in advance to store an application belonging to the application group having application group ID 2 (hereinafter, type-2 application), or to be used by the type-2 application. Furthermore, according to the original access information in the access permissions information 1000 stored by the protection settings information storage module 661, this area is prepared in advance such that reading and writing are both allowed for the VM having VM ID 1020 0, that reading is allowed while writing is not allowed for the VM having VM ID 1020 2, and that neither reading nor writing are allowed for any other VMs.

A type-3 application allocation area 1105 is designated at the memory area having area ID 310 5, and corresponds to area E 505 in FIG. 5. This area is prepared in advance to store an application belonging to the application group having application group ID 3 (hereinafter, type-3 application), or to be used by the type-3 application. Furthermore, according to the original access information in the access permissions information 1000 stored by the protection settings information storage module 661, this area is prepared in advance such that reading and writing are both allowed for the VM having VM ID 1020 0, that reading is allowed while writing is not allowed for the VM having VM ID 1020 3, and that neither reading nor writing are allowed for any other VMs.

IO areas 1106, 1107, and 1008 are designated at the respective memory areas having area IDs 310 K, L, and M, and respectively correspond to areas K 506, L 507, and M 508 in FIG. 5. These areas are prepared in advance for use in a method of sharing device control among the VMs and each correspond to a shared I/O register. The areas are used to execute access settings by triggering an exception in response to an I/O operation request from an application or operating system, and to allow the hypervisor to receive the exception and to perform I/O emulation mediating or replacing the requested I/O operation. Furthermore, according to the original access information in the access permissions information 1000 stored by the protection settings information storage module 661, IO areas 106, 107, and 108 are prepared in advance such that reading and writing are both allowed for the VM having VM ID 1020 0. Specifically, IO area 1106 is prepared such that reading and writing are both allowed for all other VMs, IO area 1107 is prepared such that only writing is allowed for all other VMs, and IO area 1108 is prepared such that only reading is allowed for all other VMs.

A first virtual machine allocation area for type-2 applications 1111 is designated at the memory area having area ID 310 N, and corresponds to area N 511 in FIG. 5. This area is newly allocated to the first virtual machine 601 by the COW processor 663 performing access management by copy-on-write implementation pertaining to a type-2 application. The COW processor 663 prepares the new area by updating the access permissions information 1000 stored in the protection settings information storage module 661.

A second virtual machine allocation area for type-2 applications 1112 is designated at the memory area having area ID 310 N+1, and corresponds to area N+1 512 in FIG. 5. This area is newly allocated to the second virtual machine 602 by the COW processor 663 performing access management by copy-on-write implementation pertaining to a type-2 application. The COW processor 663 prepares the new area by updating the access permissions information 1000 stored in the protection settings information storage module 661.

A first virtual machine allocation area for type-3 applications 1113 is designated at the memory area having area ID 310 N+2, and corresponds to area N+2 513 in FIG. 5. This area is newly allocated to the first virtual machine 601 by the COW processor 663 performing access management by copy-on-write implementation pertaining to a type-3 application. The COW processor 663 prepares the new area by updating the access permissions information 1000 stored in the protection settings information storage module 661.

A third virtual machine allocation area for type-3 applications 1114 is designated at the memory area having area ID 310 N+3, and corresponds to area N+3 514 in FIG. 5. This area is newly allocated to the third virtual machine 603 by the COW processor 663 performing access management by copy-on-write implementation pertaining to a type-3 application. The COW processor 663 prepares the new area by updating the access permissions information 1000 stored in the protection settings information storage module 661.

The following describes the operations of the virtual machine system 100, with reference to the drawings.

(Operations)

The following describes the characteristic operations of the virtual machine system, namely virtual machine switching processing, memory access processing, and application execution processing.

(Virtual Machine Switching Process)

A virtual machine switching process involves switching the VM being run by the processor 101.

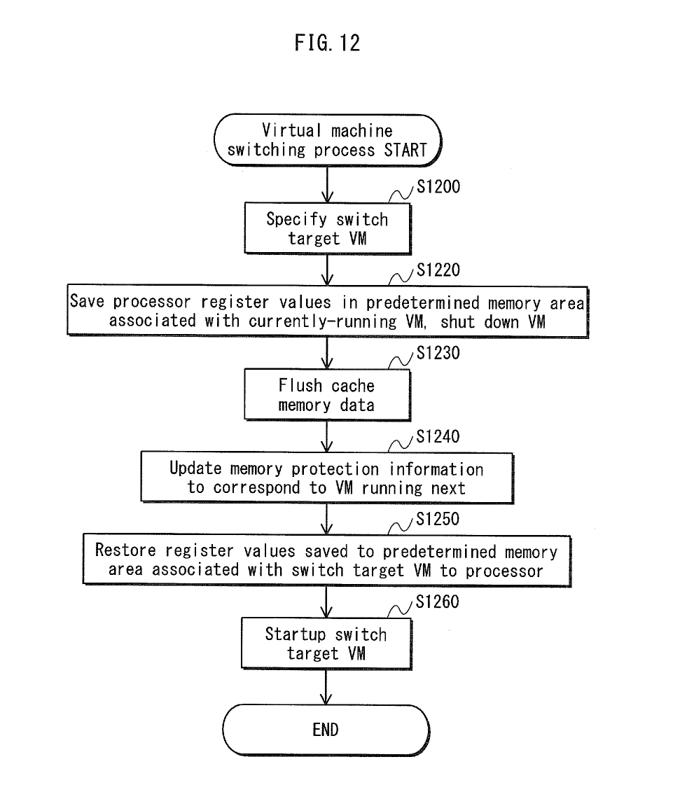

FIG. 12 is a flowchart of the virtual machine switching process.

The VM switching process is initiated by the VM execution module 652 when a predetermined interval has elapsed as measured by the timer 108, when the processor 101 receives an external interrupt request (IRQ) a VM not currently running, and so on.

Once the VM switching process begins, the VM execution module 652 specifies a switch target VM (step S1200).

Afterward, the VM execution module 652 saves the register values of the processor 101 in the predetermined memory area designated as associated with the currently-running VM, then suspends that VM (step S1220). The memory area so designated is an area of the memory 102 prepared in the hypervisor allocation area 1101 as being accessible by the hypervisor 630 only.

Subsequently, the VM execution module 652 performs a writeback process, followed by flushing, on the data stored in the cache memory 105 (step S1230). In order to avoid execution speed reductions associated with cache flushing, the cache used by each VM may be restricted and step S1230 may be omitted.

Next, the protection settings module 662 reads the access information associated with each memory ID 1010 of the VM ID 1020 (see FIG. 10) identifying the switch target VM specified by the VM execution module 652 during step S1200, generates memory protection information 400 (see FIG. 400), and updates the memory protection information 400 stored in the memory protection unit 107 with the newly-generated memory protection information 400 (step S1240).

Next, the VM execution module 652 restores the processor 101 register values saved in the memory area designated as being associated with the switch target VM (step S1250), and resumes the VM (step S1260). When the cache areas used by each VM are restricted and step S1230 is omitted, the cache area is switched during step S1260.

The virtual machine system 100 ends the VM switching process once the VM execution module 652 completes step S1260.

(Memory Access Process)

A memory access process involves the memory protection unit 107 controlling access to areas of the memory 102.

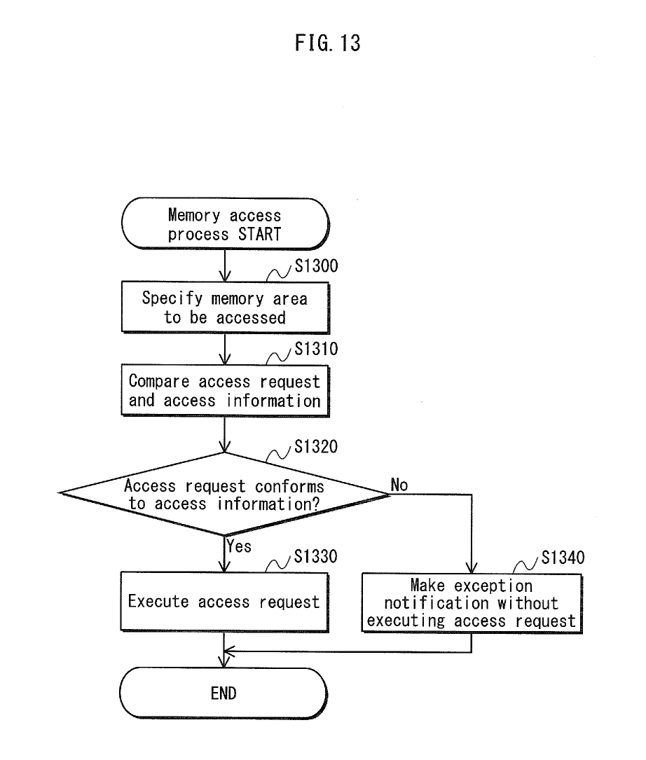

FIG. 13 is a flowchart of the memory access process.

The memory access process is initiated when the memory protection unit 107 receives a memory area access request from the processor 101 via the internal bus 120, pertaining to the memory 102.

Once the memory access process begins, the memory protection unit 107 references the memory protection table 300 (see FIG. 3) to specify the address in the received access request as one area among the memory areas each identified by an area ID 310 (step S1300).

Subsequently, the memory protection unit 107 references the memory protection information 400 (see FIG. ) and compares the access type (i.e., reading or writing) in the received request to the access information 420 associated with the area ID 410 identifying the specified area (step S1310). The memory protection unit 107 then checks whether or not the access type in the received request is allowed by the access information 420 associated with the area ID 420 identifying the specified area (step S1320).

When the access type is allowed (Yes in step S1320), the memory protection unit 107 executes the received access request (step S1330).

When the access type is not allowed (No in step S1320), the memory protection unit 107 does not execute the received access request and issues an exception notification to the processor 101 to the effect that access could not be performed (step S1340).

Once memory protection unit 107 completes step S1330 or step S1340, the virtual machine system 100 terminates the memory access process.

(Application Execution Process)

The application execution process is executed when the request reception module 654 receives a new application startup request from the operating system of currently-running VM, and involves the VM startup module 651 specifying the VM that is to execute the new application and instructing the specified VM accordingly.

The operating system of a virtual machine may make a new application startup request to the request reception module 654 when, for example, a user using the virtual machine system 100 operates the input device 131 so as to cause a task controlled by the operating system to make a new application startup request to the operating system.

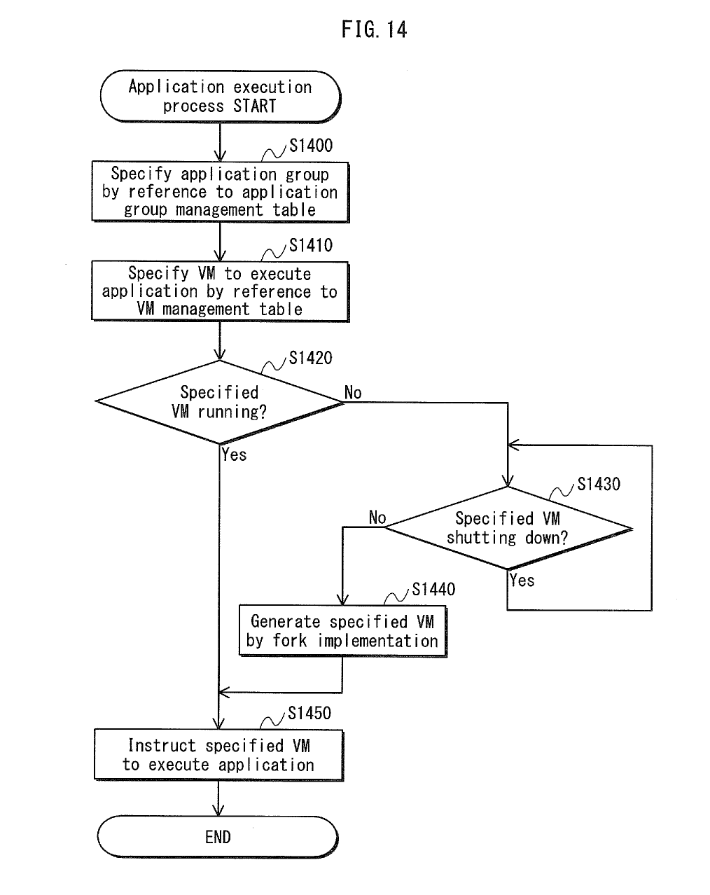

FIG. 14 is a flowchart of the application execution process.

The application execution process is initiated by the request reception module 654 receiving the new application startup request from the operating system of a running virtual machine

Upon receiving the new application startup request, the request reception module 654 transmits a signal to the VM startup module 651 indicating startup request reception.

Upon receiving this notification signal, the VM startup module 651 references the application group management table 700 stored in the VM management table storage module 640 (see FIG. 7) and specifies the application group to which the new application belongs (step S1400). The VM startup module 651 further references the VM management table 800 stored in the VM management table storage module 640 (see FIG. 8) and specifies the VM that is to execute the application belonging to the specified application group (step S1410).

Afterward, the VM startup module 651 references the VM status table 900 stored in the VM management table storage module 640 (see FIG. 9) and checks whether or not the specified VM is running (step S1420).

When the specified VM is not running (No in step S1420), the VM startup module 651 references the VM status table 900 stored in the VM management table storage module 640 to check whether or not the specified VM is shutting down (step S1430).

In the affirmative case (Yes in step S1430), the VM startup module 651 stands by until the specified VM is no longer shutting down (Yes loop in step S1430).

In the negative case (No in step S1430), the VM startup module 651 generates the specified VM by fork implementation (step S1440).

When the specified VM is running (Yes in step S1420), and when step 51440 has been completed, the VM startup module 651 transmits a signal to the operating system of the specified VM to begin execution of the subject application (step S1450).

Once VM startup module 651 has completed step S1450, the virtual machine system 100 ends the application execution process.

(Discussion)

The following discusses a specific example of the operations of the virtual machine system 100.

Specifically, let an application having the application name 720 Notepad (see FIG. 7) (hereinafter, simply Notepad) and the data used thereby be stored in the area having area ID 1010 3 (see FIG. 10). Further, let the application having the application name 720 Mailer (hereinafter, simply Mailer) and the data used thereby be stored in the area having area ID 1010 5. In this example, Notepad includes malware starting up Mailer and sending personal information registered in an address book to an outside recipient.

In the virtual machine system 100, Notepad belongs to the application group having application group ID 710 1 (see FIG. 7, application group management table 700), and is therefore executed by the virtual machine having VM ID 810 1 (hereinafter, VM 1) (see FIG. 8, VM management table 800).

When the malware included in Notepad is executed along with Notepad by VM 1, the malware makes an attempt to start Mailer.

However, Mailer and the data used thereby are stored in the area designated by area ID 1010 5. As such, the memory protection unit 107 forbids access thereto by VM 1 (see FIG. 10, access permissions information 1000). Therefore, the malware is unable to start Mailer, to tamper with Mailer, or to access the data handled by Mailer. Accordingly, the malware is unable to leak the personal information stored in the address book.

As described, in comparison to conventional technology, the virtual machine system 100 pertaining to Embodiment 1 is better able to suppress the danger posed by malware attacking sensitive applications, even when malware is included in an application being executed by a virtual machine

### Embodiment 2

(Outline)

The following describes a virtual machine system 1500, which is a variant of the virtual machine system 100 of Embodiment 1, as an Embodiment of the virtual machine system pertaining to the present invention.

A virtual machine system 1500 pertaining to Embodiment 2 has a hardware configuration and software configuration that slightly differ from those of the virtual machine system 100 pertaining to Embodiment 1.

The virtual machine system 100 pertaining to Embodiment 1 has been described in an example where the memory protection unit 107 controls access to areas of the memory 102. However, the virtual machine system 1500 pertaining to Embodiment 2 does not include a memory protection unit as hardware. Instead, in the following example, the hypervisor executed by the processor controls access to areas of the memory 102.

The virtual machine system 1500 pertaining to Embodiment 2 is described below, with reference to the drawings and with particular attention to points of difference from the virtual machine system 100 pertaining to Embodiment 1.

(Hardware Configuration)

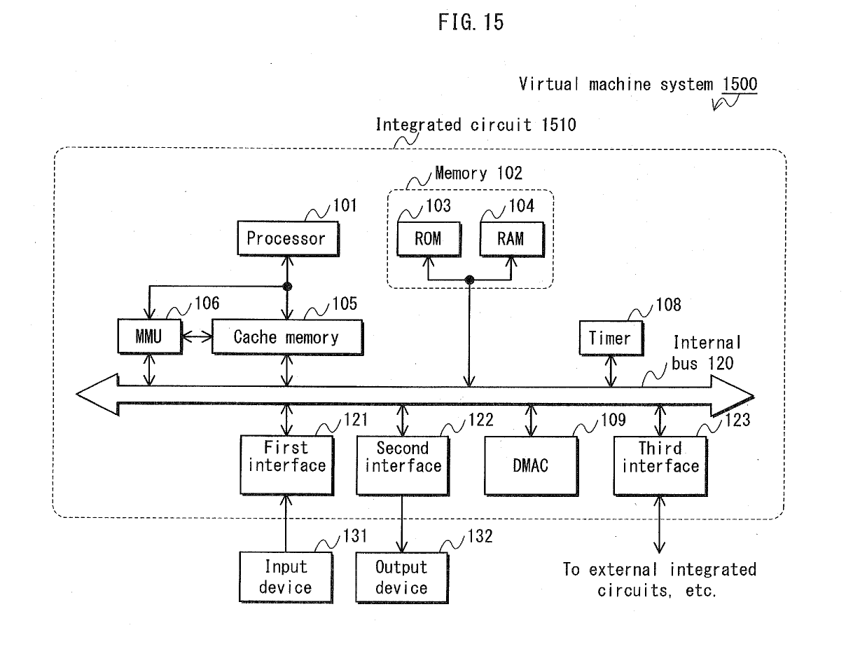

FIG. 15 is a block diagram illustrating the main hardware configuration of a virtual machine system 1500.

As shown, the virtual machine system 1500 resembles the virtual machine system 100 of Embodiment 1 in terms of computer system hardware, but differs therefrom in that integrated circuit 110 is replaced with integrated circuit 1510.

(Application Module Configuration)

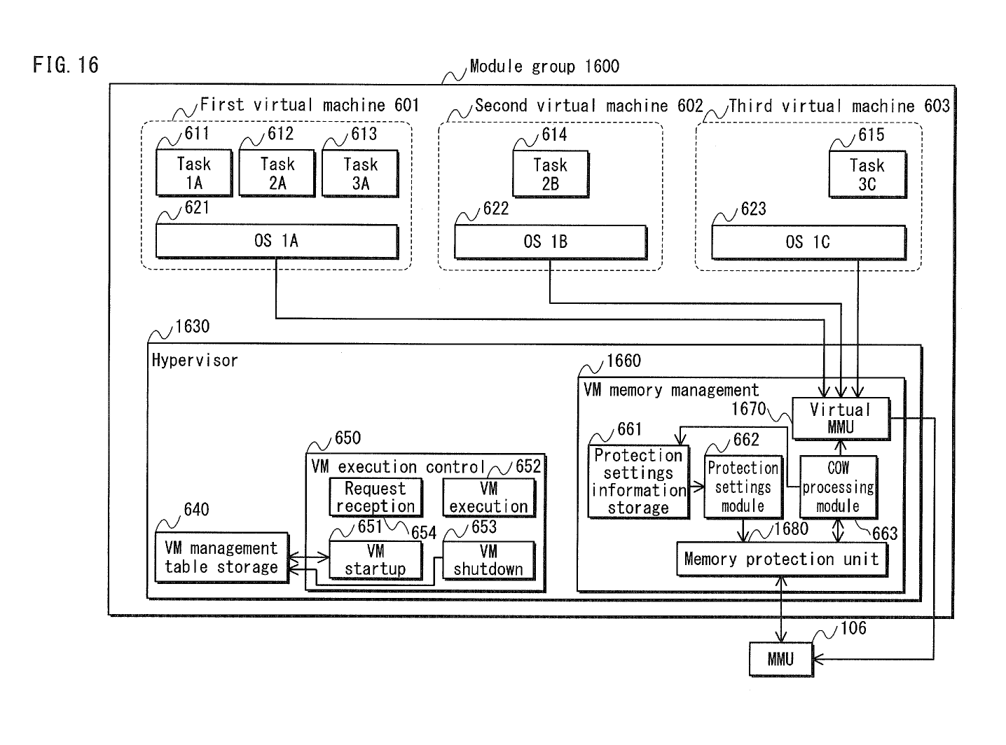

FIG. 16 is a block diagram of an application module executable by the processor 101 at time t0.

As shown, the module group 1600 is a collection of modules executed by the processor 101. Each member module of the module group 1600, and applications corresponding thereto, is stored in an area of the memory 102.

The module group 1600 of the virtual machine system 1500 differs from that of the virtual machine system 100 pertaining to Embodiment 1 in that hypervisor 630 is replaced with hypervisor 1630.

The hypervisor 1630 differs from the hypervisor 630 pertaining to Embodiment 1 in that VM memory management module 660 is replaced with VM memory management module 1660.

The VM memory management module 1660 differs from the VM memory management module 660 of Embodiment 1 in the addition of a virtual MMU 1670 and a memory protection module 1680.

The virtual MMU 1670 cooperates with the MMU 106 to convert between physical addresses, each designating a physical memory area within the memory 102, and logical addresses, each designating a logical memory area used by the processor 101.

The virtual machine system 1500 allocates physical memory areas among virtual machines in order to run the virtual machines (the physical memory areas allocated among the virtual machines are hereinafter referred to as primary logical memory areas, and addresses within the primary logical memory areas are hereinafter referred to as primary logical addresses). Each primary logical address is prepared by the MMU 106 for conversion into a physical address used by the memory 102.

The virtual MMU 1670 converts between the aforementioned primary logical addresses and logical memory addresses used by individual virtual machines (the logical memory areas used by the individual virtual machines are hereinafter referred to as secondary logical memory areas, and the addresses within the secondary logical memory areas are hereinafter referred to as secondary logical addresses).

The memory protection module 1680 stores the memory protection table 300 (see FIG. 3) and the memory protection information 400 (see FIG. 4), and references the memory protection table 300 and the memory protection information 400 to control access to the physical memory areas of the memory 102 used as the primary logical addresses by the VMs.

The access control performed by the memory protection module 1680 is identical to that performed by the memory protection unit 107 pertaining to Embodiment 1 (see heading Memory Access Process in Embodiment 1), barring the replacement of the memory protection unit 107 with the memory protection module 1680. Accordingly, explanations thereof are omitted.

Accordingly, like the virtual machine system 100 pertaining to Embodiment 1, the virtual machine system 1500 described above is, in comparison to conventional technology, better able to suppress the danger posed by malware attacking sensitive applications, even when malware is included in an application being executed by a virtual machine.

### Embodiment 3

(Outline)

The following describes a virtual machine system that is a variant of the virtual machine system 100 of Embodiment 1 as an Embodiment of the virtual machine system pertaining to the present invention.

A virtual machine system pertaining to Embodiment 3 has a hardware configuration identical to that of the virtual machine system 100 pertaining to Embodiment 1, and a software configuration that slightly differs from that of the virtual machine system 100 pertaining to Embodiment 1.

In this variant virtual machine system, only one of the virtual machines (e.g., the first virtual machine) among the running VMs directly controls devices such as the display, keyboard, and so on, even though multiple VMs are running All other VMs control the devices indirectly by making device control requests to the first virtual machine.

The variant virtual machine system 1 pertaining to Embodiment 3 is described below, with reference to the drawings and with particular attention to points of difference from the virtual machine system 100 pertaining to Embodiment 1.

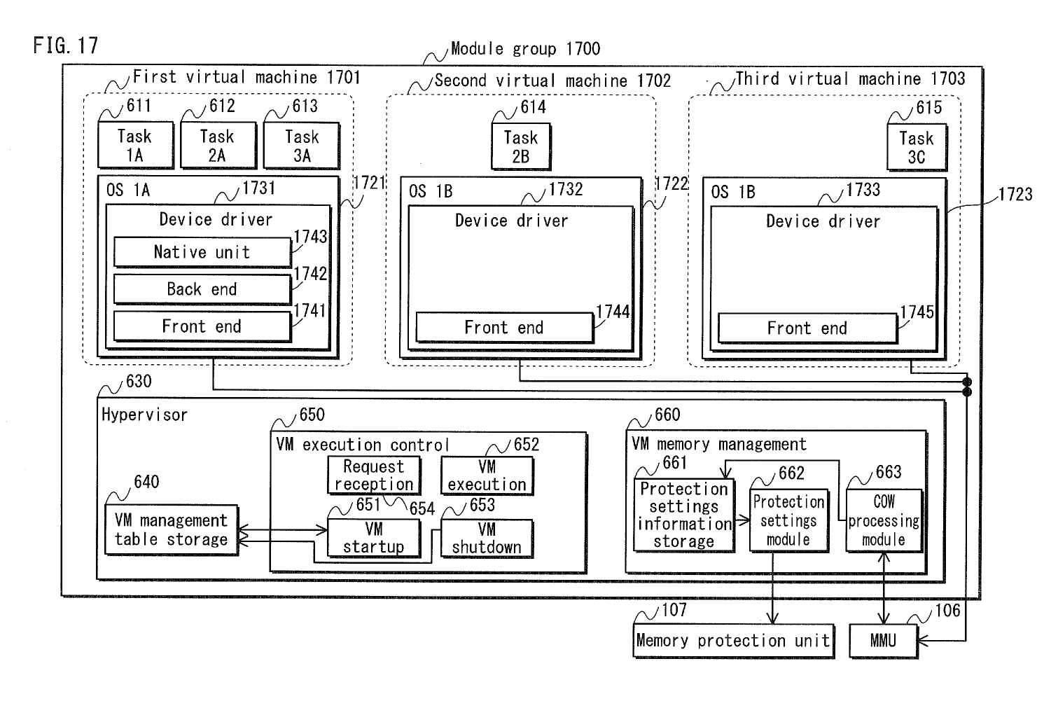

FIG. 17 is a block diagram of an application module executable by the processor 101 at time t0.

As shown, the module group 1700 is a collection of modules executed by the processor 101. Each member module of the module group 1700, and applications corresponding thereto, is stored in an area of memory 102.

The module group 1700 in the variant virtual machine system differs from the module group 600 in the virtual machine system 100 pertaining to Embodiment 1 in that the first virtual machine 601, the second virtual machine 602, and the third virtual machine 603 are respectively replaced by a first virtual machine 1701, a second virtual machine 1702, and a third virtual machine 1703.

The first virtual machine 1701 has VM ID 1020 0, serves as the parent VM for all other VMs, and differs from the first virtual machine 601 of Embodiment 1 in that OS 1A 621 has been modified into OS 1A 1721 and includes a device driver 1731.

The second virtual machine 1702 is generated by the VM startup module 651 through fork implementation, taking the first virtual machine 1701 as parent VM, in order to execute task 2B 614, and differs from the second virtual machine 602 of Embodiment 1 in that OS 1B 622 has been modified into OS 1B 1722 and includes a device driver 1732.

The third virtual machine 1702 is generated by the VM startup module 651 through fork implementation, taking the first virtual machine 1701 as parent VM, in order to execute task 3C 615, and differs from the third virtual machine 603 of Embodiment 1 in that OS 1C 623 has been modified into OS 1C 1723 and includes a device driver 1733.

The device driver 1731 is made up of a front end 1741, a back end 1742, and a native unit 1743. A device driver is an application for controlling some type of device. However, in this example, the device driver includes applications for realizing VM I/O, including device control processing, file system processing, inter-process communication processing, inter-VM communication processing, and so on.

The native unit 1743 is made up of instruction code for directly controlling a target device and serves to control the device.

As defined in the access permissions information 1000 (see FIG. 10) stored in the protection settings information storage module 661, the memory area in the memory 102 storing this application has access information reading R/W for the first virtual machine 1701 only, and reading NA for all other VMs. Accordingly, the native unit 1743 cannot be executed by any VM other than the first virtual machine 1701.

The back end 1742 communicates with the front end in the same VM thereas and with the front end in other VMs in a server-client model, receives operation commands for the native unit 1743 from the front end in such communication, and outputs the operation commands so received to the native unit 1743. The back end 1742 also receives data from the native unit 1743 and outputs the received data to the front end in communication therewith.

As defined in the access permissions information 1000 stored in the protection settings information storage module 661, the memory area in the memory 102 storing this application has access information reading R/W for the first virtual machine 1701 only, and reading NA for all other VMs. Accordingly, the back end 1742 cannot be executed by any VM other than the first virtual machine 1701.

The front end 1741 communicates with the back end 1742 in the server-client model, transmits operation commands for the native unit 1743 to the back end 1742, and receives data from the back end such in communication.

As defined in the access permissions information 1000 stored in the protection settings information storage module 661, the memory area in the memory 102 storing this application has access information reading R/W for the first virtual machine 1701 only, and reading RO for all other VMs. Accordingly, a front end is executable by all VMs (corresponding to the front ends 1741, 1744, and 1745 in FIG. 17). When the front end is being run by a plurality of VMs, the memory area storing the front end is managed by the COW processor 663 through copy-on-write implementation.

Device driver 1732 is generated from device driver 1731 when the second virtual machine 1702 and includes a front end 1744 based on front end 1741.

Device driver 1732 includes neither a native unit nor a back end. However, the memory areas of the memory 102 storing the native unit 1743 and the back end 1742 can neither be read nor written to by the second virtual machine 1702. Therefore, device driver 1732 is unable to run the native unit and the back end.

Device driver 1733 is generated from device driver 1731 along with the third virtual machine 1703 and includes a front end 1745 based on front end 1741.

Device driver 1733 includes neither a native unit nor a back end. However, the memory areas of the memory 102 storing the native unit 1743 and the back end 1742 can neither be read nor written to by the third virtual machine 1703. Therefore, device driver 1733 is unable to run the native unit and the back end.

(Device Control Example)

The following describes indirect device control by a VM that does not include the native unit 1743, such as the second virtual machine 1702.

In order to perform indirect device control, the second virtual machine 1702 first outputs an operation command for the native unit 1743 to the front end 1744. Upon receiving the operation command for the native unit 1743, the front end 1744 communicates with the back end 1742 in the server-client model and transmits the operation command thereto. Upon receiving the operation command, the back end 1742 outputs the operation command to the native unit 1743. Accordingly, the second virtual machine is able to control the device.

As such, according to the variant virtual machine system pertaining to Embodiment 3, when a plurality of VMs are running, only the native unit 1743 of the first virtual machine 1701 directly controls the devices, such that device control is performed exclusively thereby.

(Supplement)

Embodiments 1, 2, and 3, above, each describe an Embodiment of the virtual machine system pertaining to the present invention. However, the following variations are also possible. No limitation to the virtual machine system is intended by the above-described Embodiments.

(1) Embodiment 1 describes the virtual machine system 100 as having a single processor. However, provided that the hypervisor is capable of running a plurality of VMs, there is no need to limit the quantity of processors as such. Two, three, or more processors may also be used. When a plurality of processors are used, the hypervisor need not be limited to running virtual machines by time-sharing, and may alternatively run a plurality of virtual machines in parallel.

(2) In Embodiment 1, the integrated circuit 110 is described as having the processor 101, the memory 102, the cache memory 105, the MMU 106, the memory protection unit 107, the timer 108, the DMAC 109, the internal bus 120, the first interface 121, the second interface 122, and the third interface 123 integrated therein. However, these circuits need not necessarily all be integrated as a single integrated circuit. For example, the processor 101 and the cache memory 105 may be integrated as a first integrated circuit while the remaining circuits are integrated as a second integrated circuit, or each individual circuit may be integrated as a separate integrated circuit.

(3) Embodiment 1 describes the processor 101 as having two operating modes. However, the quantity of operating modes is not limited as such. Three or more may be used, such as a mode for executing an application, a mode for executing an operating system, a higher-level privileged mode for executing the hypervisor, and so on. In such circumstances, the mode for executing the hypervisor can be made a privileged mode at a higher level than the mode for executing the operating system, thus greatly reducing the processing overhead of virtual MMU processing, I/O emulation, and so on for the hypervisor.

(4) In Embodiment 1, the first virtual machine 601 is described as serving as the parent VM to all other VMs. However, no particular limitation is intended, provided that access control to the memory areas of the memory 102 for each generated child VM can be realized. For example, the child VM of a given VM may serve as the parent VM for another VM.

(5) In Embodiment 1, the VMs are described as being generated through fork implementation. This is due to the fact that VM generation by fork implementation is an efficient way of using memory areas in the memory 102.

However, when inefficiencies regarding the usage of memory areas in the memory 102 are tolerable, fork implementation need not necessarily be used to generate a child VM from a VM serving as parent.

For example, a new VM may be generated by copying the memory areas allocated to the parent VM to the memory areas for the newly-generated VM such that the respective memory areas are in one-to-one correspondence.

Also, when the memory areas of the child VM are copied from those of the parent VM, these memory areas need not necessarily be managed through copy-on-write implementation.

(6) In Embodiment 2, the virtual MMU 1670 converting between primary and secondary logical addresses is described as being included within the hypervisor 1630. However, the virtual MMU 1670 need not necessarily be included in the hypervisor 1630, provided that conversion between primary and secondary logical addresses is realizable thereby. For example, hardware capable of converting between primary and secondary logical addresses may be provided in the integrated circuit 1510.

(7) The following describes the virtual machine system pertaining to the present invention, along with a variation thereon and the effects thereof.

(a) In one aspect of the present invention, a virtual machine system includes a memory unit, a processor connected to the memory unit, and a hypervisor running on the processor and causing the processor to perform execution control on a plurality of virtual machines, the virtual machine system comprising an access controller controlling access by the virtual machines to memory areas of the memory unit, wherein the memory unit includes a first memory area storing a type-1 program and a second memory area storing a type-2 program, the hypervisor includes: a startup request reception module for receiving a type-1 or type-2 program startup request from the virtual machines; and a virtual machine generation module for, upon receipt of the type-1 program startup request by the startup request reception module, generating a new virtual machine for executing the type-1 program and managing the new virtual machine as a type-1 virtual machine, and for, upon receipt of the type-2 program startup request by the startup request reception module, generating a new virtual machine for executing the type-2 program and managing the new virtual machine as a type-2 virtual machine, and the access controller performs access control so as to forbid access to the second memory area by the new virtual machine managed by the virtual machine generation module as the type-1 virtual machine.

According to the virtual machine system having the above-described configuration, an unauthenticated application is stored as a type-1 program in the first memory area, while an authenticated application is stored as a type-2 program in the second memory area. Thus, a virtual machine executing the unauthenticated application is unable to access the authenticated application.

Accordingly, although an application subject to execution by the virtual machine contains an authenticated application in combination with an unauthenticated application, the risk of malware executed and included in the unauthenticated application attacking the authenticated application is reduced, in comparison to conventional technology.

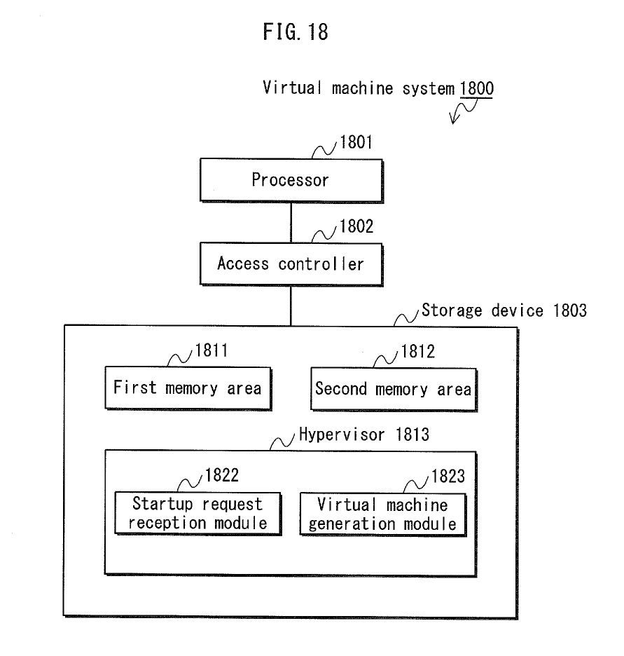

FIG. 18 is an overall outline diagram of a virtual machine system 1800 pertaining to the above-described variation.

As shown, the virtual machine system 1800 includes a processor 1801, an access controller 1802, and a storage device 1803. The storage device 1803 in turn includes a first memory area 1811 and a second memory area 1812, and has a hypervisor 1813 loaded therein. The hypervisor 1813 also includes a startup request reception module 1822 an a virtual machine generation module 1823.

The processor 1801 is connected to the storage device 1803 via the access controller 1802. For example, the processor may be realized as the processor 101 (see FIG. 1) of Embodiment 1.

The storage device 1803 includes the first memory area 1811 and the second memory area 1812. For example, the storage device may be realized as the memory 102 (see FIG. 1) of Embodiment 1.

The first memory area 1811 stores a type-1 program. For example, the first memory area 1811 may be realized as area C 503 (see FIG. 5) of Embodiment 1. Also, the type-1 program may be realized as the Notepad (see FIG. 7) of Embodiment 1.

The second memory area 1812 stores a type-2 program. For example, the second memory area 1812 may be realized as area E 505 (see FIG. 5) of Embodiment 1. Also, the type-2 program may be realized as the Mailer (see FIG. 7) of Embodiment 1.

The hypervisor 1813 is executed by the processor 1801, controls the execution of a plurality of VMs thereby, and includes the startup request reception module 1822 and the virtual machine generation module 1823. For example, the hypervisor 1813 may be realized as the hypervisor 630 (see FIG. 6) of Embodiment 1.

The startup request reception module 1822 is code for receiving a startup request for the type-1 program or the type-2 program. For example, the startup request reception module may be realized as the request reception module 654 of Embodiment 1.

When the startup request reception module 1822 executed by the processor 1801 receives a startup request for the type-1 program, the virtual machine generation module 1823 generates a new VM for executing the type-1 program and manages the new VM so generated as a type-1 VM. Similarly, when the startup request is for the type-2 application, the virtual machine generation module 1823 generates a new VM for executing the type-2 program and manages the new VM so generated as a type-2 VM. For example, the virtual machine generation module may be realized as the VM startup module 651 and the VM execution module 652 of Embodiment 1.

The access controller 1802 controls access by the VMs to the memory areas of the storage device 1803 by forbidding the VM managed as the type-1 VM by the virtual machine generation module 1823 executed by the processor 1801 from accessing the second memory area. For example, the access controller 1822 may be realized as the memory protection unit 107 (see FIG. 1) of Embodiment 1.

(b) Also, the access controller may have a specification information storage unit for storing second memory area specification information specifying a second memory area address, and controls the access by the virtual machines to memory areas of the memory unit with reference to the second memory area specification information.

According to this configuration, the access controller is able to specify the second memory area address in a manner that cannot be externally referenced.

(c) Further, the memory unit may include a program association information storage area for storing program association information indicating program-specifying information in association with program type-specifying information, the virtual machine generation module may include a program type specifier for specifying, with reference to the program association information, a type of program as indicated in a program startup request received by the startup request reception module from a source virtual machine, and the virtual machine generation module may manage the new virtual machine as one of (i) the type-1 virtual machine generated upon receipt of the type-1 program startup request by the startup request reception module, and (ii) the type-2 virtual machine generated upon receipt of the type-2 program startup request by the startup request reception module, according to the type of program specified by the program type specifier.

According to this configuration, the virtual machine generation module performs type-specific virtual machine management based on the program association information stored in the program association information memory area.

(d) In addition, when generating the new virtual machine upon receipt of the type-1 or type-2 program startup request from the source virtual machine by the startup request reception module, the virtual machine generation module may allocate the memory areas of the memory unit to the new virtual machine by fork implementation according to the memory areas allocated to the source virtual machine making the program startup request.

According to this configuration, a new virtual machine is generated by fork implementation, thus enabling efficient use of the memory areas in the storage device.

(e) Alternatively, the hypervisor further may include a copy-on-write execution controller for controlling access to the memory areas of the memory unit by the virtual machines such that access to the memory areas by the first virtual machine and the second virtual machine is performed through copy-on-write implementation when the virtual machine generation module has allocated memory areas to the first virtual machine by fork implementation according to the memory areas allocated to the second virtual machine.

According to this configuration, access by the parent VM to memory areas and memory area management for the child VM generated from the parent VM by fork implementation are both performed through copy-on-write implementation, thus enabling efficient use of the memory areas of the memory unit.

(f) Furthermore, the first memory area may further include an area storing data used when the type-1 program is executed by the virtual machines, and the second memory area may further include an area storing data used when the type-2 program is executed by the virtual machines

According to this configuration, the virtual machine executing the type-1 program is prevented from using data used by the virtual machine executing the type-2 program.

(g) Further still, the memory unit may include: a device driver storage area storing a device driver; and a device control program storage area storing a device control program for communicating with a single virtual machine executing the device driver and for causing the single virtual machine to control a device, through execution of the program by another virtual machine not executing the device driver, and the access controller may perform access control such that access to the device driver storage area is restricted to the single virtual machine among the plurality of virtual machines subject to execution control.

According to this configuration, exclusive device control is achievable for each of a plurality of virtual machines.

### INDUSTRIAL APPLICABILITY

The present invention is widely applicable to virtual machine systems.

### REFERENCE SIGNS LIST

100 Virtual machine system

110 Integrated circuit

101 Processor

102 Memory

103 ROM

104 RAM

105 Cache memory

106 Memory management unit

107 Memory protection unit

108 Timer

109 DMAC

120 Internal bus

600 Module group

601 First virtual machine

602 Second virtual machine

603 Third virtual machine

630 Hypervisor

640 VM management table storage module

650 VM execution control module

651 VM startup module

652 VM execution module

653 VM shutdown module

654 Request reception module

660 VM memory management module

661 Protection settings information storage module

662 Protection settings module

663 COW process module

1. A virtual machine system including a memory unit, a processor connected to the memory unit, and a hypervisor running on the processor and causing the processor to perform execution control on a plurality of virtual machines, the virtual machine system comprising
an access controller controlling access by the virtual machines to memory areas of the memory unit, wherein
the memory unit includes a first memory area storing a type-1 program and a second memory area storing a type-2 program,
the hypervisor includes:
a startup request reception module for receiving a type-1 or type-2 program startup request from the virtual machines; and
a virtual machine generation module for, upon receipt of the type-1 program startup request by the startup request reception module, generating a new virtual machine for executing the type-1 program and managing the new virtual machine as a type-1 virtual machine, and for, upon receipt of the type-2 program startup request by the startup request reception module, generating a new virtual machine for executing the type-2 program and managing the new virtual machine as a type-2 virtual machine, and
the access controller performs access control so as to forbid access to the second memory area by the new virtual machine managed by the virtual machine generation module as the type-1 virtual machine.

2. The virtual machine system of claim 1, wherein
the access controller has a specification information storage unit for storing second memory area specification information specifying a second memory area address, and controls the access by the virtual machines to memory areas of the memory unit with reference to the second memory area specification information.

3. The virtual machine system of claim 2, wherein
the memory unit includes a program association information storage area for storing program association information indicating program-specifying information in association with program type-specifying information,
the virtual machine generation module includes a program type specifier for specifying, with reference to the program association information, a type of program as indicated in a program startup request received by the startup request reception module from a source virtual machine, and
the virtual machine generation module manages the new virtual machine as one of (i) the type-1 virtual machine generated upon receipt of the type-1 program startup request by the startup request reception module, and (ii) the type-2 virtual machine generated upon receipt of the type-2 program startup request by the startup request reception module, according to the type of program specified by the program type specifier.

4. The virtual machine system of claim 3, wherein
when generating the new virtual machine upon receipt of the type-1 or type-2 program startup request from the source virtual machine by the startup request reception module, the virtual machine generation module allocates the memory areas of the memory unit to the new virtual machine by fork implementation according to the memory areas allocated to the source virtual machine making the program startup request.

5. The virtual machine system of claim 4, wherein
the hypervisor further includes a copy-on-write execution controller for controlling access to the memory areas of the memory unit by the virtual machines such that access to the memory areas by the first virtual machine and the second virtual machine is performed through copy-on-write implementation when the virtual machine generation module has allocated memory areas to the first virtual machine by fork implementation according to the memory areas allocated to the second virtual machine

6. The virtual machine system of claim 5, wherein
the first memory area further includes an area storing data used when the type-1 program is executed by the virtual machines, and
the second memory area further includes an area storing data used when the type-2 program is executed by the virtual machines

7. The virtual machine system of claim 5, wherein
the memory unit includes:
a device driver storage area storing a device driver; and
a device control program storage area storing a device control program for communicating with a single virtual machine executing the device driver and for causing the single virtual machine to control a device, through execution of the program by another virtual machine not executing the device driver, and
the access controller performs access control such that access to the device driver storage area is restricted to the single virtual machine among the plurality of virtual machines subject to execution control.

8. A virtual machine control method for controlling a virtual machine system that includes a memory unit, a processor connected to the memory unit, a hypervisor running on the processor and causing the processor to perform execution control on a plurality of virtual machines, and an access controller controlling access by the virtual machines to memory areas of the memory unit, the memory unit including a first memory area storing a type-1 program and a second memory area storing a type-2 program, the virtual machine control method comprising:
a startup request reception step of the hypervisor receiving a type-1 or type-2 program startup request from the virtual machines;
a virtual machine generation step of the hypervisor, upon receipt of the type-1 program startup request during the startup request reception step, generating a new virtual machine for executing the type-1 program and managing the new virtual machine as a type-1 virtual machine, and, upon receipt of the type-2 program startup request during the startup request reception step, generating a new virtual machine for executing the type-2 program and managing the new virtual machine as a type-2 virtual machine; and
an access control step of the access controller performing access control so as to forbid access to the second memory area by the new virtual machine managed as the type-1 virtual machine.

9. A virtual machine control program for controlling a virtual machine system that includes a memory unit, a processor connected to the memory unit, a hypervisor running on the processor and causing the processor to perform execution control on a plurality of virtual machines, and an access controller controlling access by the virtual machines to memory areas of the memory unit, the memory unit including a first memory area storing a type-1 program and a second memory area storing a type-2 program, the virtual machine control method comprising:
a startup request reception step of the hypervisor receiving a type-1 or type-2 program startup request from the virtual machines;
a virtual machine generation step of the hypervisor, upon receipt of the type-1 program startup request during the startup request reception step, generating a new virtual machine for executing the type-1 program and managing the new virtual machine as a type-1 virtual machine, and, upon receipt of the type-2 program startup request during the startup request reception step, generating a new virtual machine for executing the type-2 program and managing the new virtual machine as a type-2 virtual machine; and
an access control step of the access controller performing access control so as to forbid access to the second memory area by the new virtual machine managed as the type-1 virtual machine

10. A semiconductor integrated circuit including a memory unit, a processor connected to the memory unit, and a hypervisor running on the processor and causing the processor to perform execution control on a plurality of virtual machines, the semiconductor integrated circuit comprising
an access controller controlling access by the virtual machines to memory areas of the memory unit, wherein
the memory unit includes a first memory area storing a type-1 program and a second memory area storing a type-2 program,
the hypervisor includes:
a startup request reception module for receiving a type-1 or type-2 program startup request from the virtual machines; and
a virtual machine generation module for, upon receipt of the type-1 program startup request by the startup request reception module, generating a new virtual machine for executing the type-1 program and managing the new virtual machine as a type-1 virtual machine, and for, upon receipt of the type-2 program startup request by the startup request reception module, generating a new virtual machine for executing the type-2 program and managing the new virtual machine as a type-2 virtual machine, and
the access controller performs access control so as to forbid access to the second memory area by the new virtual machine managed by the virtual machine generation module as the type-1 virtual machine.
